(19) United States
(12) Patent Application Publication
(10) Pub. No.: US 2026/0326642 A1
(43) Pub. Date: Oct. 22, 2026

(54) SEAT

(71) Applicant: Alps Alpine Co., Ltd., Ota-ku (JP)

(72) Inventors: Shinichi SAGAWAI, Miyagi-ken (JP); Kunio SATO, Miyagi-ken (JP); Keigo ABE, Miyagi-ken (JP)

(21) Appl. No.: 19/629,647

(22) Filed: Mar. 26, 2026

(30) Foreign Application Priority Data
Apr. 17, 2025 (JP) 2025-068237

(51) Int. Cl. B60N 2/90

(52) U.S. Cl. CPC B60N 2/90; B60N 2002/981

(57) ABSTRACT

A seat includes a seat body, at least one vibration unit embedded in a seating portion of the seat body, and a drive unit configured to drive the vibration unit. The vibration unit includes a vibration element that vibrates in a first direction that is parallel to a seat surface of the seating portion and a vibration plate that extends from the vibration element and transmits the vibration of the vibration element. The vibration plate has an elongated shape, extends in a second direction parallel to the seat surface of the seating portion and perpendicular to the first direction, and has a greater length in the second direction than in the first direction.

### CLAIM OF PRIORITY

This application claims benefit of Japanese Patent Application No. 2025-068237 filed on Apr. 17, 2025, which is hereby incorporated by reference.

### BACKGROUND OF THE INVENTION

### 1. Field of the Invention

The present invention relates to a seat.

### 2. Description of the Related Art

International Publication No. WO 2024/209841 discloses a technology in which an actuator mounted in a vehicle seat is configured to generate rocking vibration (arcuate vibration) to transmit the rocking vibration (arcuate vibration) to a vehicle occupant.

However, in the technology described in International Publication No. WO 2024/209841, it is difficult to generate pronounced rocking vibration (arcuate vibration). In addition, placing the vibration element in the area where vibration is to be generated (that is, at the center of the seat) restricts the placement of other components, which may be problematic.

### SUMMARY OF THE INVENTION

According to one embodiment, a seat includes a seat body, at least one vibration unit embedded in a seating portion of the seat body, and a drive unit configured to drive the vibration unit. The vibration unit includes a vibration element that vibrates in a first direction that is parallel to a seat surface of the seating portion and a vibration plate that extends from the vibration element and transmits the vibration of the vibration element. The vibration plate has an elongated shape, extends in a second direction parallel to the seat surface of the seating portion and perpendicular to the first direction, and has a greater length in the second direction than in the first direction.

According to the seat of one embodiment, the vibration element can be disposed in the seating portion at a position that does not limit the placement of other components and allows pronounced rocking vibration (arcuate vibration) to be transmitted to a broad area of the seating portion.

### BRIEF DESCRIPTION OF THE DRAWINGS

FIG. 1 illustrates the configuration of a seat according to an embodiment;

FIG. 2 is a plan view of the seating portion of the seat according to the embodiment;

FIG. 3 is a cross-sectional view of the seating portion taken along line III-III shown in FIG. 2;

FIG. 4 is a cross-sectional view of the seating portion taken along line IV-IV shown in FIG. 2;

FIG. 5 illustrates a first example of driving of two vibration elements by a driving device provided for the seat according to the embodiment;

FIG. 6 illustrates a second example of driving of the two vibration elements by the driving device provided for the seat according to the embodiment;

FIG. 7 is a plan view of the seating portion of a seat according to a first modification of the embodiment;

FIG. 8 is a plan view of the seating portion of a seat according to a second modification of the embodiment;

FIG. 9 is a plan view of the seating portion of a seat according to a third modification of the embodiment.

FIG. 10 is a plan view of the seating portion of a seat according to a fourth modification of the embodiment;

FIG. 11 illustrates an example of the acceleration obtained by the seat illustrated in FIG. 2 according to the embodiment;

FIG. 12 illustrates an example of the acceleration obtained by the seat illustrated in FIG. 10 according to the fourth modification of the embodiment;

FIG. 13 illustrates an example of the acceleration obtained by the seat illustrated in FIG. 9 according to the third modification of the embodiment;

FIG. 14 is a plan view of the seating portion of a seat according to a fifth modification of the embodiment;

FIG. 15 illustrates the vibration acceleration of the seat according to the fifth modification of the embodiment and that of a comparative seat according to a first comparative example;

FIG. 16 is a plan view of the seating portion of a seat according to a second comparative example;

FIGS. 17A and 17B illustrate the vibration acceleration of the seat according to the fifth modification of the embodiment and that of a comparative seat according to the second comparative example; and

FIG. 18 illustrates the cross-sectional details of the seating portion of the seat according to the embodiment.

### DESCRIPTION OF THE PREFERRED EMBODIMENTS

One embodiment is described below with reference to the accompanying drawings. In the following description, for convenience, the Z-axis direction (corresponding to the up-down direction of the vehicle) in the drawings is referred to as the up-down direction, the Y-axis direction (corresponding to the left-right direction of the vehicle) in the drawings is referred to as a left-right direction, and the X-axis direction (corresponding to the front-rear direction of the vehicle) in the drawings is referred to as a front-rear direction. However, the positive Z-axis direction corresponds to the upward direction, the positive Y-axis direction corresponds to the rightward direction, and the positive X-axis direction corresponds to the forward direction.

### Configuration of Seat

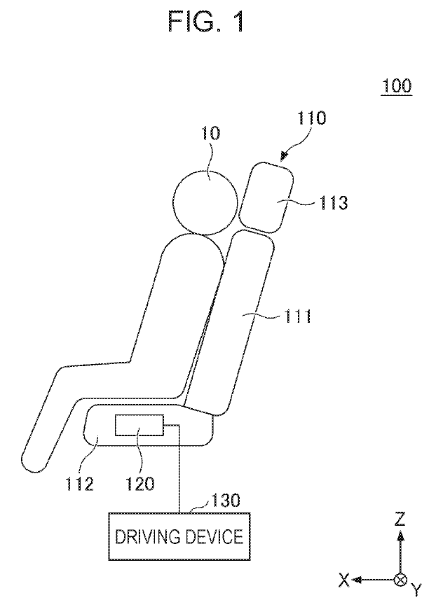

FIG. 1 illustrates the configuration of a seat 100 according to one embodiment. The seat 100 illustrated in FIG. 1 is mounted in a vehicle and is intended to be seated by a vehicle occupant 10. As illustrated in FIG. 1, the seat 100 includes a seat body 110, a vibration unit 120, and a driving device 130.

The seat body 110 has a backrest 111, the seating portion 112, and a headrest 113. Each of the backrest 111, the seating portion 112, and the headrest 113 includes a frame, a cushion 114, and a seat fabric. The frame constitutes the structure of the seat 100. The cushion 114 is formed of foam, such as urethane foam, and is disposed on the frame. The seat fabric is formed of fabric (e.g., woven fabric), leather, or another suitable material and covers the surface of the cushion 114. The frame and seat fabric are not illustrated.

The vibration unit 120 is provided inside the cushion 114 of the seating portion 112 of the seat body 110 and embedded therein. The vibration unit 120 can generate vibration and transmit the vibration to the occupant 10 seated on the seat surface of the seating portion 112.

### Configuration of Vibration Unit

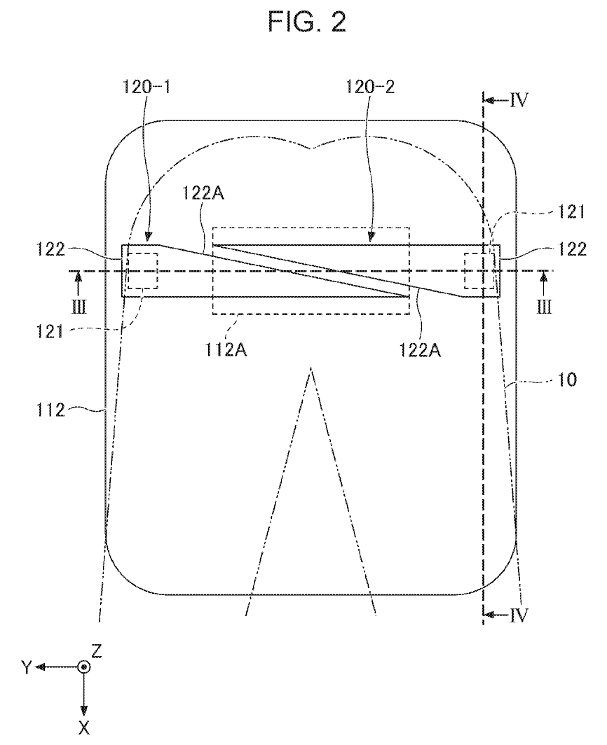

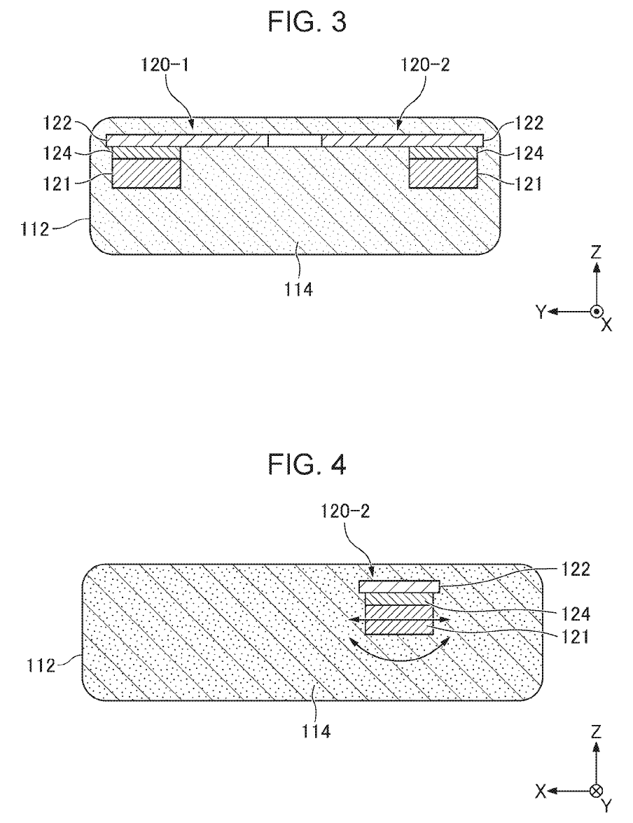

FIG. 2 is a plan view of the seating portion 112 of the seat 100 according to the embodiment. FIG. 3 is a cross-sectional view of the seating portion 112 taken along line III-III shown in FIG. 2. FIG. 4 is a cross-sectional view of the seating portion 112 taken along line IV-IV shown in FIG. 2.

As illustrated in FIGS. 2 and 4, the vibration unit 120 is disposed in a rear (negative X-axis) region and upper (positive Z-axis) region of the cushion 114 of the seating portion 112. For example, the cushion 114 may be formed with an internal space large enough to accommodate the vibration unit 120 and a cut extending from the outer surface to the space, and the vibration unit 120 may be disposed in the space through the cut.

Alternatively, a recess leading from the outer surface of the cushion 114 to the space in which the vibration unit 120 is disposed may be provided on the outer surface of the cushion 114. After the vibration unit 120 is disposed in the recess, the recess may be closed with another cushion so that the vibration element is embedded inside the cushion 114.

These configurations allow the outer surface of the vibration unit 120 to be embedded inside the cushion 114, with the cushion surrounding the vibration unit 120, rather than the vibration unit 120 being exposed on the outer surface of the cushion 114.

As illustrated in FIGS. 2 and 3, the seat 100 includes a pair of vibration units 120 (120-1 and 120-2), one on each side in the left-right direction. The vibration units 120 each include a vibration element 121, a vibration plate 122, and a weight 124.

The vibration element 121 is provided inside the seating portion 112 near the edge of the seating portion 112 in the left-right direction (Y-axis direction).

For example, the vibration element 121 included in the vibration unit 120-1 on the right (positive Y-axis) side is disposed inside the seating portion 112 near the right end (positive Y-axis end) of the seating portion 112. For example, the vibration element 121 included in the vibration unit 120-2 on the eft (negative Y-axis) side is disposed inside the seating portion 112 near the left end (negative Y-axis end) of the seating portion 112.

The vibration element 121 is driven by the driving device 130 to vibrate in the front-rear direction (X-axis direction), which is an example of a "first direction".

The vibration plate 122 is a flat plate-shaped member disposed parallel to the XY plane. The vibration plate 122 is formed of a rigid material (e.g., stainless steel, hard resin, or the like). The vibration plate 122 has a longitudinal shape, with the left-right direction (Y-axis direction) serving as its longitudinal direction and the front-rear direction (X-axis direction) serving as its lateral direction. Since the vibration plate 122 has a rigid body, it vibrates in the same manner as the vibration element 121, as a single unit.

The vibration plate 122 is fixed to the upper surface of the vibration element 121, which is disposed near the edge of the seating portion 112 in the left-right direction (Y-axis direction), via a weight 124 and by a fixing means such as adhesive. The vibration plate 122 extends from the vibration element 121 toward the opposite end of the seating portion 112 in the left-right direction (Y-axis direction). The left-right direction (Y-axis direction) is an example of a "second direction".

For example, the vibration plate 122 included in the vibration unit 120-1 disposed on the right (positive Y-axis) side is fixed to the upper surface of the vibration element 121 disposed near the right end (the positive Y-axis end) of the seating portion 112 by a fixing means. The vibration plate 122 extends in the leftward direction (negative Y-axis direction) from the vibration element 121 toward the left (negative Y-axis) end of the seating portion 112.

In addition, for example, the vibration plate 122 included in the vibration unit 120-2 disposed on the left side (negative Y-axis side) is fixed to the upper surface of the vibration element 121 disposed near the left end (the negative Y-axis end) of the seating portion 112 by a fixing means. The vibration plate 122 extends in the rightward direction (positive Y-axis direction) from the vibration element 121 toward the right (positive Y-axis) end of the seating portion 112.

The vibration plate 122 may have a plurality of holes formed therein. For example, even when a blower member configured to blow air upward (to the surface of the seating portion 112) is disposed below the vibration plate 122 in the seating portion 112, this structure minimizes obstruction of the upward airflow generated by the blower member.

As illustrated in FIGS. 3 and 4, the weight 124 is disposed between the lower surface of the vibration plate 122 and the upper surface of the vibration element 121. The weight 124 adjusts the center of gravity of the vibration element 121. This ensures that when the vibration element 121 vibrates in the front-rear direction (X-axis direction), the vibration plate 122 undergoes a pronounced rocking vibration (arcuate vibration) in the front-rear direction (X-axis direction). The material of the weight is not particularly limited, and may include, for example, iron, molybdenum, or the like. The weight 124 may be disposed on an upper portion of the vibration plate 122 or inside the vibration element 121.

The driving device 130 is electrically connected to the vibration element 121 by a wiring member, such as a lead wire (not illustrated). The driving device 130 vibrates the vibration element 121 by supplying a drive signal to the vibration element 121.

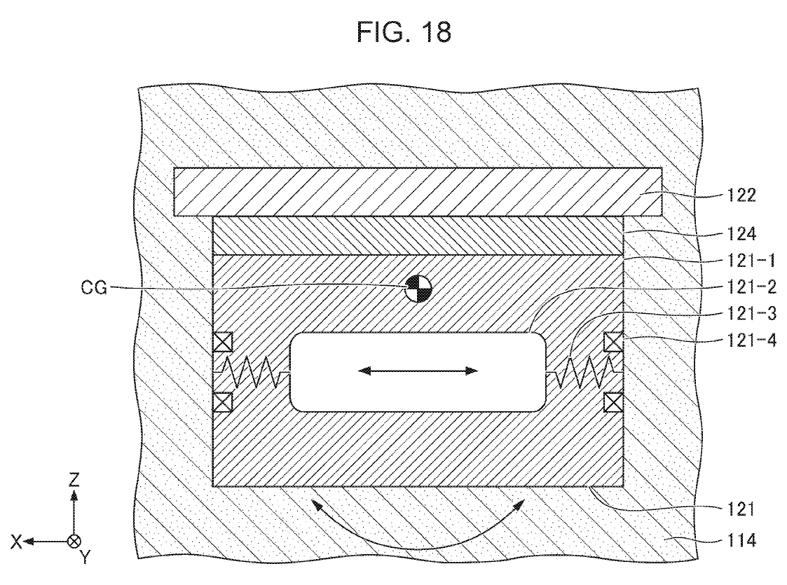

The rocking vibration (arcuate vibration) of the vibration unit 120 is generated by embedding the vibration unit 120 inside the cushion 114 and vibrating the vibration element 121 horizontally in the front-rear direction (X-axis direction). This vibration is described below with reference to FIG. 18. FIG. 18 illustrates the cross-sectional details of the seating portion 112 of the seat 100 according to the embodiment.

As illustrated in FIG. 18, the vibration element 121 includes a housing 121-1, a driving member 121-2, springs 121-3, and coils 121-4. The driving member 121-2 is provided with a permanent magnet and is held by a pair of the front and rear springs 121-3 in a movable manner in the front-rear direction (X-axis direction) inside the housing 121-1. The coils 121-4 are attached to the housing 121-1. By supplying an AC current to the coils 121-4, the driving member 121-2 is caused to perform reciprocating vibration in the front-rear direction (X-axis direction) through the action of a permanent magnet in the driving member 121-2.

The vibration unit 120 is embedded inside the cushion 114 and is held only by the cushion 114. Because the cushion 114 is soft, the vibration unit 120 can easily move in the same manner in any direction and thus is kept floating inside the cushion 114. In addition, since the vibration element 121 is provided with the weight 124, a center of gravity CG of the vibration unit 120 is shifted from the center of the driving member 121-2 toward the weight 124 (positive Z-axis direction). Therefore, when the driving member 121-2 vibrates in the X-axis direction, the vibration unit 120 does not vibrate in the X-axis direction, but generates an arcuate (rocking) vibration about the center of gravity CG. The configuration of the vibration element 121 is not limited to that illustrated in FIG. 18, as long as it is capable of generating vibration in at least the X-axis direction.

As illustrated in FIG. 2, the vibration plate 122 has an elongated shape such that its length in the left-right direction (Y-axis direction) is greater than that in the front-rear direction (X-axis direction). In particular, according to the present embodiment, the vibration plate 122 has an elongated shape that gradually tapers (that is, the width in the X-axis direction gradually decreases) from the end fixed to the vibration element 121 toward the tip. Furthermore, according to the present embodiment, the vibration plate 122 has a triangular shape that gradually tapers from the end fixed to the vibration element 121 to the tip.

A pair of the vibration plates 122 is disposed facing each other in the left-right direction (Y-axis direction), and the vibration plates 122 extend in the left-right direction (Y-axis direction) toward each other. Since each extended portion has a triangular shape, the oblique sides 122A of the extended portions face each other with a predetermined gap, as illustrated in FIG. 2. As a result, the extended portions do not interfere with each other. In particular, according to the present embodiment, since the pair of vibration plates 122 has the same shape, the extended portions can be disposed so as not to interfere with each other by rotating one of the vibration plates 122 180° in the XY plane.

As illustrated in FIG. 4, the seat 100 according to the embodiment has the vibration plate 122 with a greater length in the left-right direction (Y-axis direction) and a smaller length in the front-rear direction (X-axis direction), so that vibrating the vibration element 121 in the front-rear direction (X-axis direction) causes the vibration plate 122 to undergo pronounced rocking vibration (arcuate vibration) in the front-rear direction (X-axis direction).

In addition, according to the seat 100 of the embodiment, the vibration element 121, having a large thickness (dimension in the Z-axis direction), can be disposed at a position that does not interfere with other components (for example, the blower member configured to blow air upward to the surface of the seating portion 112) disposed in the seating portion 112, and can transmit the vibration of the vibration element 121 via the vibration plate 122 to a broad area of the seating portion 112. As a result, even when the vibration element 121 is disposed at a position that avoids interference with other components, the vibration can be transmitted to the occupant 10.

The vibration from the vibration element 121 is difficult to transmit to the occupant 10 due to the intervening cushion 114. However, the seat 100 according to the embodiment can generate a pronounced rocking vibration due to the long length of the vibration plate 122 in the left-right direction (Y-axis direction), and the vibration can be transmitted to a broad area of the seating portion 112. As a result, the vibration can be transmitted to the occupant 10.

According to the present embodiment, the vibration unit 120 is embedded in the cushion 114 so that no gap exists between the cushion 114 and the vibration unit 120. However, since it is sufficient that the vibration of the vibration plate 122 is transmitted to the cushion 114, the vibration plate 122 and the cushion 114 need to be at least in tight contact with each other, and, for example, a gap may exist between the vibration element 121 and the cushion 114.

The seat 100 according to the embodiment includes the pair of vibration plates 122 disposed to face each other in the left-right direction (Y-axis direction), thus allowing vibration to be transmitted to the occupant 10 over a broad area of the seating portion 112.

The seat 100 according to the embodiment has an overlapping region 112A where a region in which a portion (triangular portion) of one vibration plate 122 extends and a region in which a portion (triangular portion) of the other vibration plate 122 extends overlap each other in the left-right (Y-axis) and front-rear (X-axis) directions of the seating portion 112 (refer to FIG. 2). Therefore, in this overlapping region 112A, the seat 100 according to the embodiment can transmit the vibration of one vibration plate 122 and the vibration of the other vibration plate 122 either simultaneously or separately to the occupant 10.

The seat 100 according to the embodiment can be disposed so that the pair of vibration plates 122 do not interfere with each other even when the length of each of the two vibration plates 122 in the left-right direction (Y-axis direction) is increased. As a result, the pair of vibration plates 122 can be accommodated within the width of a single vibration plate 122 in the front-rear direction (X-axis direction).

### Example of Driving of Two Vibration Elements

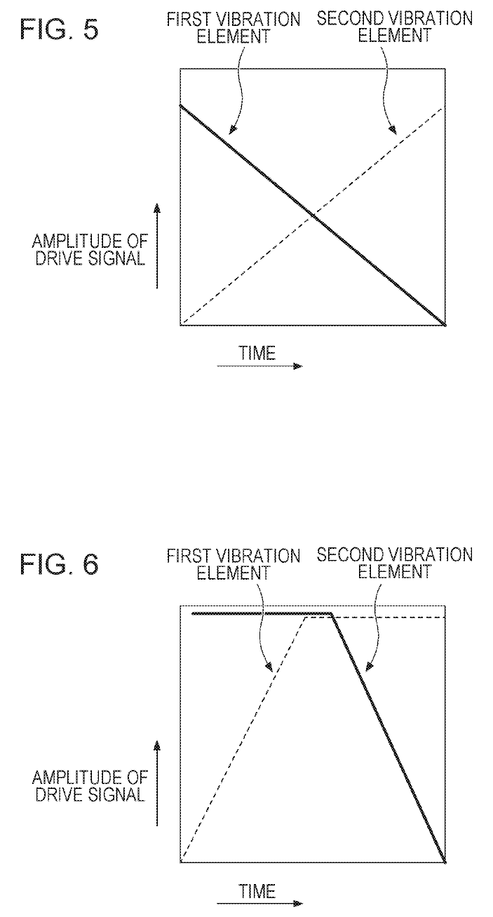

FIG. 5 illustrates a first example of driving of two vibration elements 121 by the driving device 130 provided for the seat 100 according to the embodiment. As illustrated in FIG. 5, the driving device 130 may gradually reduce the amplitude of the drive signal of one vibration element 121 (first vibration element) to vibrate the vibration element 121 (first vibration element) while simultaneously gradually increasing the amplitude of the drive signal of the other vibration element 121 (second vibration element) to vibrate the vibration element 121 (second vibration element).

The frequency of the drive signal is set to the same value as the natural frequency of the vibration element 121, the vibration frequency of the vibration element 121 is the same as the frequency of the drive signal, and the amplitude of vibration of the vibration element 121 is proportional to the amplitude of the drive signal. Therefore, in FIG. 5, the amplitude of the drive signal plotted on the ordinate axis may be regarded as the amplitude of the vibration element 121. According to the present embodiment, the vibration frequency of the vibration element 121 is set to 140 Hz, for example, to optimize human perception of the vibration, and the time from the maximum to the minimum of the drive signal is set to a value sufficiently longer than the period of vibration of the vibration element 121, which has 1/140 second, for example, 2 seconds.

FIG. 6 illustrates a second example of driving of the two vibration elements 121 by the driving device 130 provided for the seat 100 according to the embodiment. The driving device 130 may control the amplitudes of the drive signals as illustrated in FIG. 6. More specifically, the driving device 130 may vibrate the vibration elements 121 such that the amplitude of the drive signal of the one vibration element 121 (first vibration element) is gradually increased, that is, the amplitude of the one vibration element 121 (first vibration element) is gradually increased, while the amplitude of the drive signal of the other vibration element 121 (second vibration element) is maintained constant, that is, the amplitude of the other vibration element 121 (second vibration element) is maintained constant. Thereafter, the driving device 130 may vibrate the vibration elements 121 such that the amplitude of the drive signal of the other vibration element 121 (second vibration element) is gradually decreased, that is, the amplitude of the other vibration element 121 (second vibration element) is gradually decreased, while the amplitude of the drive signal of the one vibration element 121 (first vibration element) is maintained constant, that is, the amplitude of the one vibration element 121 (first vibration element) is maintained constant.

As illustrated in FIGS. 5 and 6, the driving device 130 may drive one vibration element 121 and the other vibration element 121 by controlling the amplitude of the drive signal so that the amplitude of the one vibration element 121 gradually increases while the amplitude of the other vibration element 121 gradually decreases. This allows the driving device 130 to provide the occupant 10 with a sensation that the vibration is moving smoothly in the left-right direction (Y-axis direction).

The driving device 130 drives one vibration element 121 and the other vibration element 121 so that the vibration direction of one vibration element 121 and the vibration direction of the other vibration element 121 are aligned in the same front-rear direction.

The driving device 130 may drive one vibration element 121 and the other vibration element 121 so that one vibration element 121 vibrates in the forward direction (positive X-axis direction) and the other vibrates in the rearward direction (negative X-axis direction), that is, in mutually opposite directions in the front-rear direction.

### First Modification of Seat

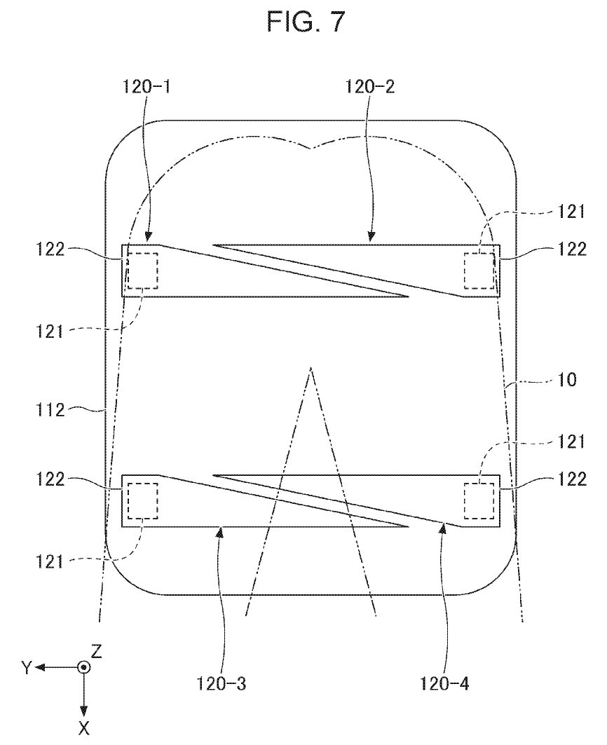

FIG. 7 is a plan view of the seating portion 112 of a seat 100 according to the first modification of the embodiment. As illustrated in FIG. 7, the seat 100 according to the first modification may include a first pair of vibration units 120-1 and 120-2 embedded in the rear region of the cushion of the seating portion 112 and a second pair of vibration units 120-3 and 120-4 embedded in the front region of the cushion of the seating portion 112.

In this case, as illustrated in FIG. 7, the pair of vibration elements 121 included in the first pair of vibration units 120-1 and 120-2 may be disposed at the left and right ends of the seating portion 112, and the pair of vibration elements 121 included in the second pair of vibration units 120-3 and 120-4 may be disposed at the left and right ends of the seating portion 112. The four vibration elements 121 illustrated in FIG. 7 all vibrate in the front-rear direction (X-axis direction).

This allows the seat 100 according to the first modification to transmit rocking vibrations over a broad area in the left-right (Y-axis) and front-rear (X-axis) directions at the front and rear regions of the seating portion 112 to the occupant 10.

In addition, in the seat 100 according to the first modification, this allows the pair of left and right vibration elements 121 in each of the front and rear regions of the seating portion 112 to be disposed at positions that do not interfere with other components disposed in the center of the seating portion 112 (for example, a blower member configured to blow air upward to the surface of the seating portion 112).

### Second Modification of Seat

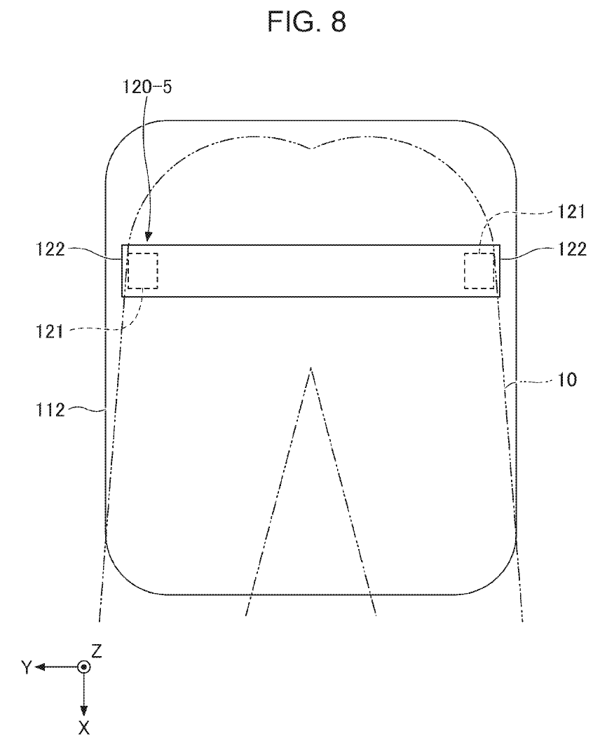

FIG. 8 is a plan view of the seating portion 112 of a seat 100 according to the second modification of the embodiment. As illustrated in FIG. 8, the seat 100 according to the second modification may include, embedded in the rear region of the cushion of the seating portion 112, a vibration unit 120-5 that has a pair of left and right vibration elements 121 and a vibration plate 122 that connects the two vibration elements 121.

In this case, as illustrated in FIG. 8, the pair of vibration elements 121 of the vibration unit 120-5 may be disposed at the left and right ends of the seating portion 112. The pair of vibration elements 121 illustrated in FIG. 8 vibrates in the front-rear direction (X-axis direction).

This allows the seat 100 according to the second modification to transmit rocking vibrations over a broad area in the left-right (Y-axis) and front-rear (X-axis) directions at the rear region of the seating portion 112 to the occupant 10.

In addition, in the seat 100 according to the second modification, this allows the pair of left and right vibration elements 121 in the rear region of the seating portion 112 to be disposed at positions that do not interfere with other components disposed in the center of the seating portion 112 (for example, a blower member configured to blow air upward to the surface of the seating portion 112).

### Third Modification of Seat

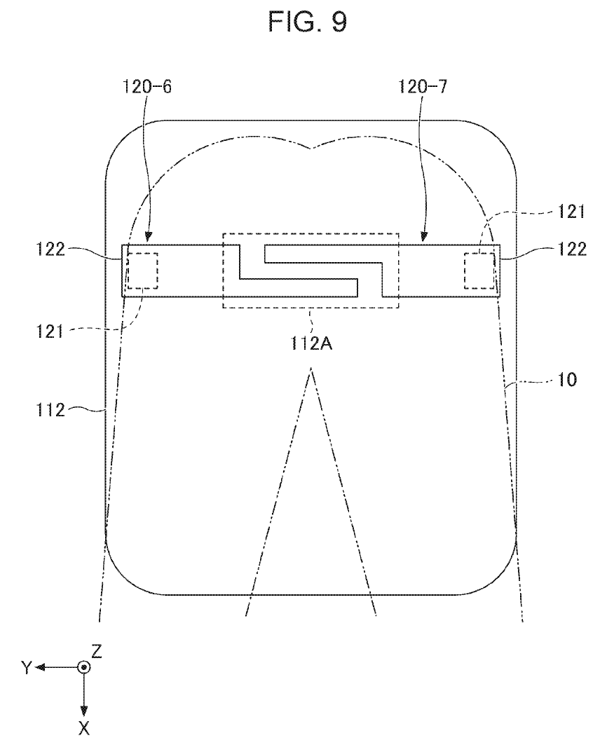

FIG. 9 is a plan view of the seating portion 112 of a seat 100 according to a third modification of the embodiment. As illustrated in FIG. 9, the seat 100 according to the third modification may include, embedded in a rear region of the cushion of the seating portion 112, a pair of left and right vibration units 120-6 and 120-7 having vibration plates 122 with shapes different from those illustrated in FIG. 2 and other figures.

The seat 100 according to the third modification of the embodiment has an overlapping region 112A (refer to FIG. 9) where a region in which a portion of one vibration plate 122 extends and a region in which a portion of the other vibration plate 122 extends overlap each other in the left-right (Y-axis) and front-rear (X-axis) directions of the seating portion 112.

In the example illustrated in FIG. 9, each of the pair of vibration plates 122 has a predetermined first width in the front-rear direction (X-axis direction) from the end (the side connected to the vibration element 121) to the middle part and extends in the left-right direction (Y-axis direction). From the middle part to the tip, the vibration plate 122 has a predetermined second width in the front-rear direction (X-axis direction), smaller than the first width, and extends in the left-right direction (Y-axis direction).

Even in this case, as illustrated in FIG. 9, by inverting one of the two vibration plates 122 and disposing the vibration plates 122 so as to face each other, the length of each vibration plate 122 can be increased in the left-right direction (Y-axis direction) without interfering with each other.

### Fourth Modification of Seat

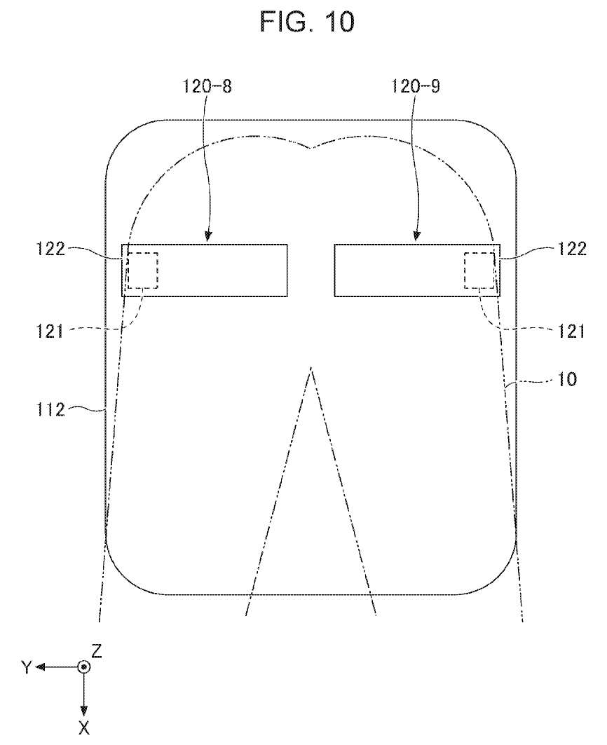

FIG. 10 is a plan view of the seating portion 112 of a seat 100 according to the fourth modification of the embodiment. As illustrated in FIG. 10, the comparative seat according to the fourth modification includes a pair of left and right vibration units 120-8 and 120-9 embedded in the rear region of the cushion of the seating portion 112, each having a simple horizontally elongated rectangular vibration plate 122.

### Seat Surface Acceleration by Drive Signal

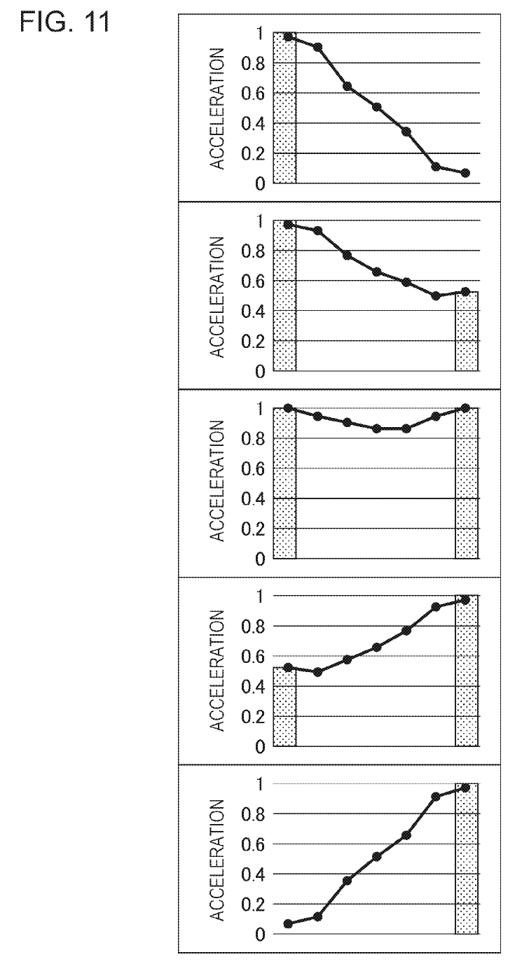

FIG. 11 illustrates an example of the acceleration obtained by the seat 100 illustrated in FIG. 2 according to the embodiment, when the amplitude of the drive signal is controlled as illustrated in FIG. 6.

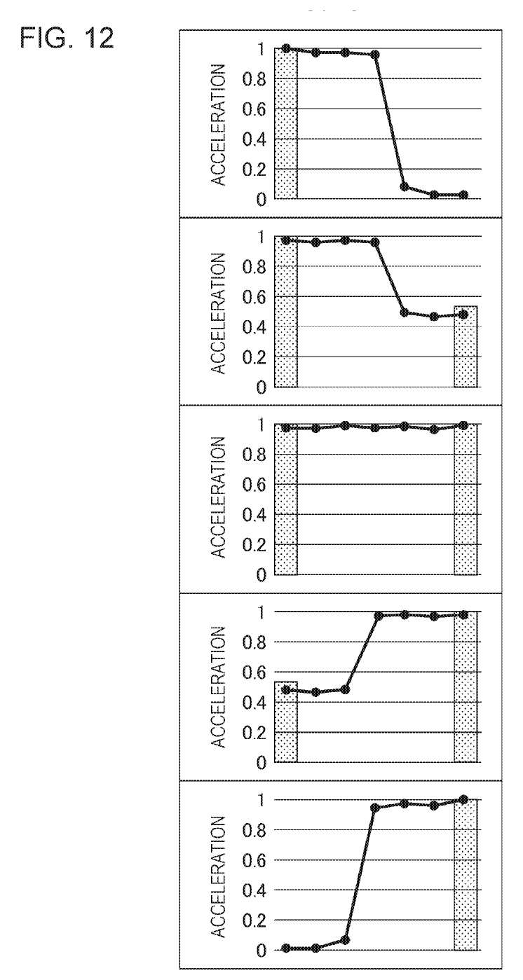

FIG. 12 illustrates an example of the acceleration obtained by the seat 100 illustrated in FIG. 10 according to the fourth modification, when the amplitude of the drive signal is controlled as illustrated in FIG. 6.

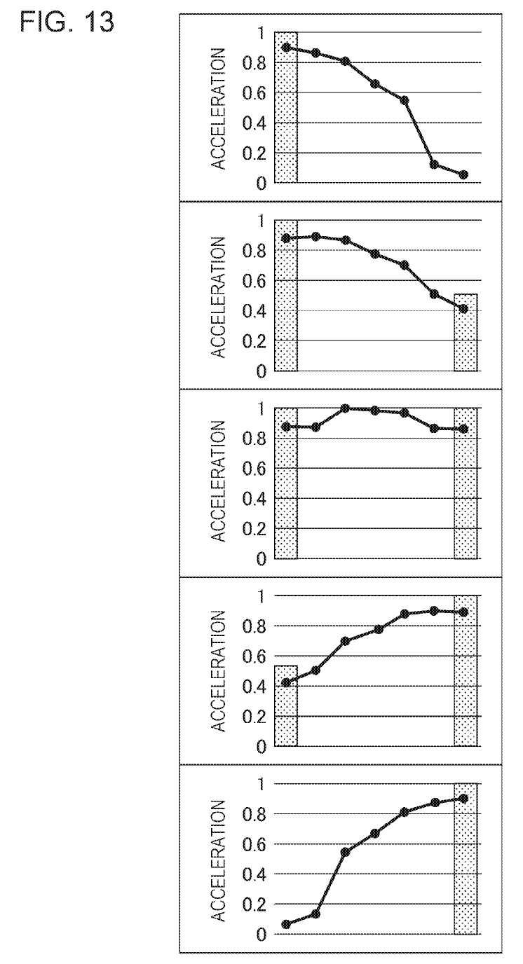

FIG. 13 illustrates an example of the acceleration obtained by the seat 100 illustrated in FIG. 9 according to the third modification, when the amplitude of the drive signal is controlled as illustrated in FIG. 6.

In FIGS. 11 to 13, the left bar in the graph illustrates the amplitude of the drive signal of one vibration element 121 (first vibration element), and the right bar in the graph illustrates the amplitude of the drive signal of the other vibration element 121 (second vibration element).

In FIGS. 11 to 13, the amplitude of the drive signal of one vibration element 121 (first vibration element) and that of the other vibration element 121 (second vibration element) are the same with respect to time. More specifically, as illustrated in FIG. 6, the amplitude of the drive signal of one vibration element 121 (first vibration element) gradually increases and then becomes constant. The amplitude of the drive signal of the other vibration element 121 (second vibration element) gradually decreases after remaining constant.

The five graphs illustrated in FIG. 11 represent the surface acceleration of the seating portion 112 of the seat 100 according to the embodiment, which is obtained by gradually changing the ratio between the driving forces (amplitudes of the drive signals) of one vibration element 121 and the other vibration element 121. Each of the graphs represent the accelerations obtained at a plurality of measurement positions located in the left-right direction (Y-axis direction) at the center of the vibration plate 122 in the front-rear direction.

Similarly, the five graphs illustrated in FIG. 12 represent the surface acceleration of the seating portion 112 of the seat illustrated in FIG. 10 according to the fourth modification, which is obtained by gradually changing the ratio between the driving forces of one vibration element 121 and the other vibration element 121. The accelerations are obtained at the plurality of measurement positions located in the left-right direction (Y-axis direction) at the center of the vibration plate 122 in the front-rear direction.

Similarly, the five graphs illustrated in FIG. 13 represent the surface acceleration of the seating portion 112 of the seat illustrated in FIG. 9 according to the third modification, which is obtained by gradually changing the ratio between the driving forces of one vibration element 121 and the other vibration element 121. The accelerations are obtained at the plurality of measurement positions located in the left-right direction (Y-axis direction) at the center of the vibration plate 122 in the front-rear direction.

As illustrated in FIGS. 11 and 13, in both cases, in the seat 100 according to the embodiment, a difference in acceleration between the plurality of measurement positions is small regardless of the ratio between the driving forces of one vibration element 121 and the other vibration element 121. The graphs show smooth graph waveform, with gentle changes in acceleration at each position.

In contrast, as illustrated in FIG. 12, in the seat according to the fourth modification illustrated in FIG. 10, when the ratio between the driving forces of one vibration element 121 and the other vibration element 121 is changed, the difference in acceleration between any two adjacent measurement positions is large, and the graph waveform changes abruptly in part. In addition, the acceleration at each measurement position changes either very little or changes abruptly.

### Fifth Modification of Seat

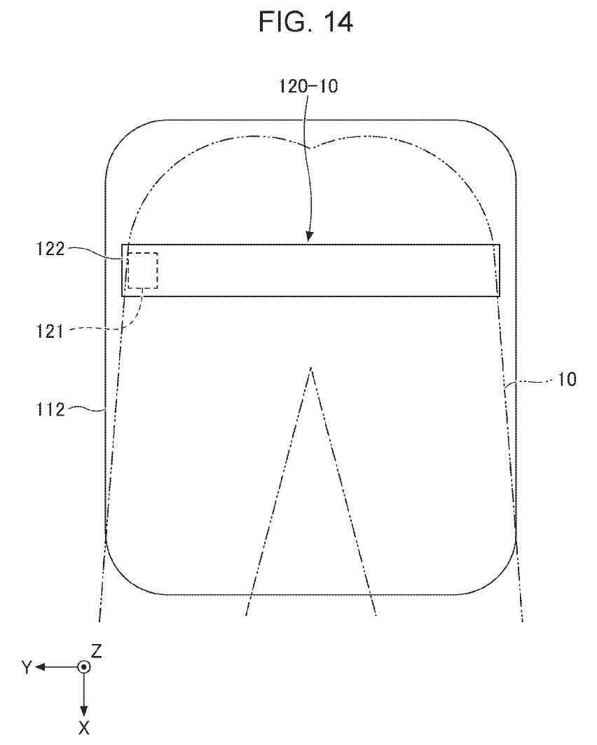

FIG. 14 is a plan view of the seating portion 112 of a seat 100 according to the fifth modification of the embodiment. As illustrated in FIG. 14, the seat 100 according to the fifth modification may include a vibration unit 120-10 having a vibration element 121 that vibrates in the front-rear direction and a vibration plate 122 that extends from the vibration element 121 in the left-right direction, embedded in a rear region of the cushion of the seating portion 112.

In this case, as illustrated in FIG. 14, the vibration element 121 of the vibration unit 120-10 may be disposed at the right end of the seating portion 112.

This allows the seat 100 according to the fifth modification to transmit rocking vibrations over a broad area in the left-right (Y-axis) and front-rear (X-axis) directions at the rear region of the seating portion 112 to the occupant 10.

In addition, in the seat 100 according to the fifth modification, this allows the vibration element 121 to be disposed in the rear region of the seating portion 112 at a position that do not interfere with other components disposed in the center of the seating portion 112 (for example, a blower member configured to blow air upward to the surface of the seating portion 112).

### Vibration Accelerations of Fifth Modification and First Comparative Example

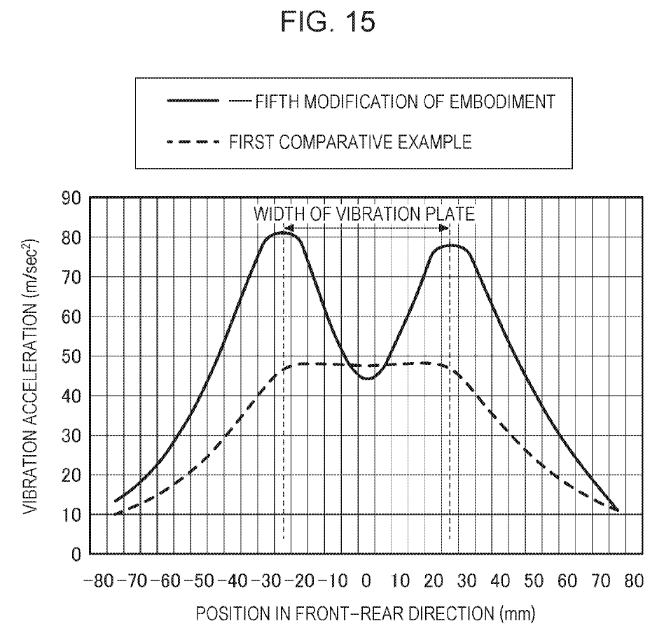

FIG. 15 illustrates the vibration accelerations of the seat 100 according to the fifth modification of the embodiment illustrated in FIG. 14 and a seat according to a first comparative example. The vibration element 121 of the vibration unit 120-10 illustrated in FIG. 14 vibrates in the front-rear direction, whereas in the first comparative example, the only difference is that the vibration element 121 vibrates in the left-right direction. Both vibration elements are driven at a frequency of 140 Hz.

The graph illustrated in FIG. 15 represents the surface acceleration of the seating portion 112 at each of a plurality of measurement positions in the front-rear (X-axis) direction, at the center of the seating portion 112 in the left-right direction.

More specifically, the abscissa axis of the graph illustrated in FIG. 15 represents the position in the front-rear direction (X-axis direction) on the surface of the seating portion 112, with the 0-mm position corresponding to the midpoint of the vibration plate 122 in the front-rear direction. The ordinate axis represents the maximum vibration acceleration (that is, the magnitude of the vibration acceleration vector) obtained at each position.

As illustrated in FIG. 15, when a single vibration plate 122 is vibrated in the front-rear direction (X-axis direction) and the vibration unit 120-10 performs rocking vibration (arcuate vibration), as in the fifth modification, a high vibration acceleration can be obtained across substantially the entire surface of the seating portion 112 in the front-rear direction (X-axis direction), as compared with the case where a single vibration plate 122 is vibrated linearly in the left-right direction (Y-axis direction), as in the first comparative example. At the 0-mm position, however, the vibration acceleration is slightly lower since the 0-mm position corresponds to the center position of the arcuate (rocking) vibration.

Therefore, by vibrating the vibration plate 122 in the front-rear direction (X-axis direction) to cause the vibration unit 120-10 to undergo rocking vibration, a pronounced rocking vibration can be perceived by the occupant 10 over a broad area of the surface of the seating portion 112.

In particular, when the vibration plate 122 is vibrated in the front-rear direction (X-axis direction) to cause the vibration unit 120-10 to undergo rocking vibration, the maximum vibration acceleration is obtained at the position of an end of the vibration plate 122 in the front-rear direction (that is, a position on the vibration plate 122).

When the vibration plate 122 is vibrated in the front-rear direction (X-axis direction) to cause the vibration unit 120-10 to undergo rocking vibration, the vibration acceleration gradually decreases from the position of an end of the vibration plate 122 in the front-rear direction (that is, a position on the vibration plate 122) to the mid position in the front-rear direction (X-axis direction) of the vibration plate 122 (that is, the 0-mm position), and in a direction away from the vibration plate.

### Second Comparative Example of Seat

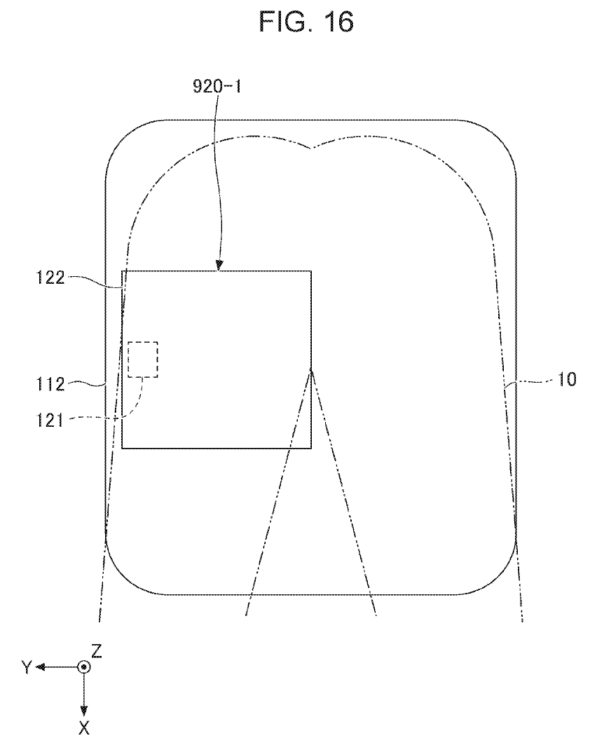

FIG. 16 is a plan view of a seating portion 112 of a seat 100 according to the second comparative example. As illustrated in FIG. 16, the seat 100 according to the second comparative example includes a vibration unit 920-1 having a vibration element 121 and a square-shaped vibration plate 122, embedded in the cushion of a seating portion 112, at the center in the front-rear direction and at the right end in the left-right direction. The vibration element 121 vibrates in the front-rear direction.

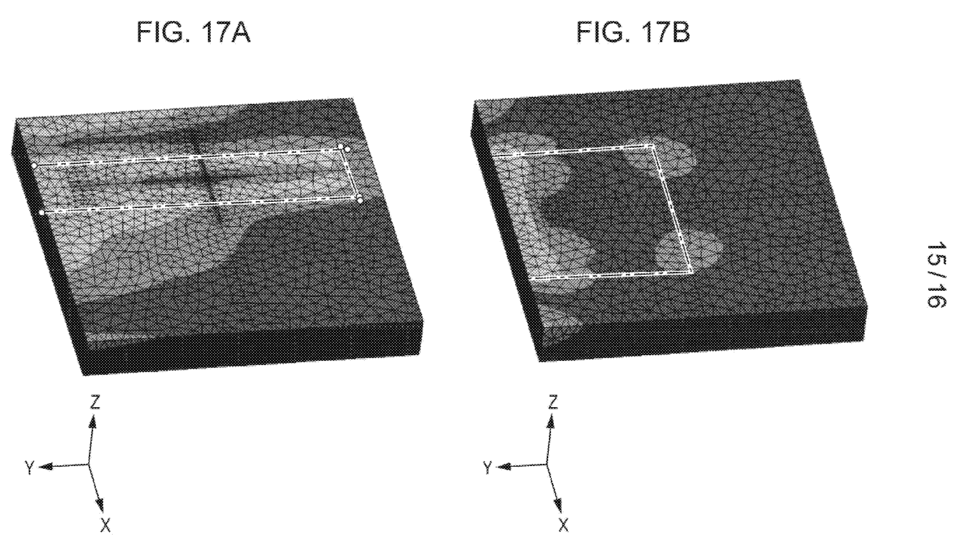

FIGS. 17A and 17B illustrate the vibration accelerations of the seat 100 according to the fifth modification of the embodiment illustrated in FIG. 14 and the comparative seat according to the second comparative example illustrated in FIG. 16. FIG. 17A is a distribution diagram illustrating the vibration acceleration of the seat 100 according to the fifth modification. FIG. 17B is a distribution diagram illustrating the vibration acceleration of the comparative seat according to the second comparative example. Each distribution diagram illustrates the distribution of the acceleration at each position on the surface of the seating portion 112 and represents the absolute maximum acceleration. A dash-dot line denotes the vibration plate 122.

The values in the front-rear direction at the center position in the left-right direction of the distribution diagram in FIG. 17A correspond to the values in the fifth modification of the embodiment shown in FIG. 15.

As illustrated in FIGS. 17A and 17B, when the vibration plate 122 having a greater dimension in the left-right direction than in the front-rear direction is vibrated in the front-rear direction, a high vibration acceleration can be obtained across substantially the entire surface of the seating portion 112 in the front-rear direction (X-axis direction), compared with the vibration plate 122 having equal dimensions in both the front-rear and left-right directions and vibrated in the front-rear direction.

As described above, each of the seats 100 according to the first to fifth modifications of the embodiment, similarly to the seat 100 according to the embodiment, includes the vibration plate 122 having a greater length in the left-right direction (Y-axis direction) than in the front-rear direction (X-axis direction). Therefore, when the vibration element 121 is vibrated in the front-rear direction (X-axis direction), the vibration plate 122 undergoes pronounced rocking vibration (arcuate vibration) in the front-rear direction (X-axis direction), and the vibration is transmitted to a broad area of the seating portion 112. Thus, even when the vibration element 121 is disposed in a position that does not interfere with other components provided in the seating portion 112 (for example, a blower member configured to blow air upward to the surface of the seating portion 112), or even when the cushion 114 is interposed around the vibration element 121, the vibration can still be reliably transmitted to the occupant 10.

While embodiments of the present invention have been described in detail above, the invention is not limited thereto, and various modifications or changes can be made within the spirit and scope of the invention, as defined by the claims.

What is claimed is:

1. A seat comprising:
a seat body;
at least one vibration unit embedded in a seating portion of the seat body; and
a drive unit configured to drive the vibration unit,
wherein the vibration unit includes a vibration element that vibrates in a first direction that is parallel to a seat surface of the seating portion, and a vibration plate that extends from the vibration element and transmits the vibration of the vibration element,
wherein the vibration plate has an elongated shape, extends in a second direction parallel to the seat surface of the seating portion and perpendicular to the first direction, and has a greater length in the second direction than in the first direction.

2. The seat according to claim 1, comprising:
a pair of the vibration units disposed facing each other in the second direction.

3. The seat according to claim 2, wherein the seat has an overlapping region where a region in which the vibration plate of one of the vibration units and a region in which the vibration plate of the other vibration unit extends overlap each other in the first and second directions.

4. The seat according to claim 3, wherein the drive unit drives the one vibration element and the other vibration element such that an amplitude of the one vibration element gradually increases while an amplitude of the other vibration element gradually decreases.

5. The seat according to claim 2, wherein the pair of vibration elements are disposed in a rear region and in left and right end regions of the seating portion.

6. The seat according to claim 1, wherein the at least one vibration unit comprises a first pair of vibration units embedded in a rear region of the seating portion and facing each other in the second direction and a second pair of vibration units embedded in a front region of the seating portion and facing each other in the second direction,
wherein a pair of vibration elements, one provided in each of the first pair of vibration unis, are disposed in left and right end regions of the seating portion, and
wherein a pair of vibration elements, one provided in each of the second pair of vibration units, are disposed in left and right end regions of the seating portion.
